(19) United States
(12) Patent Application Publication
(10) Pub. No.: US 2025/0163633 A1
(43) Pub. Date: May 22, 2025

(54) Dosing System with Spherical Housing for a Washing Machine

(71) Applicant: Henkel AG & Co. KGaA, Duesseldorf (DE)

(72) Inventors: Arnd Kessler, Monheim am Rhein (DE); Ingo Hardacker, Hamminkeln (DE); Sergio Linz, Cologne (DE); Robert Ruiz Hernandez, Duesseldorf (DE); Jan De Paepe, Velzeke (BE)

(21) Appl. No.: 19/032,660

(22) Filed: Jan. 21, 2025

Related U.S. Application Data
(63) Continuation of application No. PCT/EP2023/067974, filed on Jun. 30, 2023.

(30) Foreign Application Priority Data
Jul. 26, 2022 (EP) 22186946.4

(51) Int. Cl. D06F 39/02; C11D 17/04

(52) U.S. Cl. CPC D06F 39/024; C11D 17/046

(57) ABSTRACT

A dosing system for dosing a preparation into a washing machine, wherein the dosing system can be freely positioned in a rotatable washing drum of a washing machine, comprising a container for receiving the preparation, a dosing device that doses the preparation from the container into the washing drum, and a substantially spherical housing in which the dosing device and the container are accommodated. The surface of the spherical housing is covered with a ribbed structure, which has a plurality of spaced-apart ribs.

### FIELD OF THE INVENTION

The invention relates to a dosing system for dosing a preparation into a washing machine, wherein the dosing system can be freely positioned and freely moved in a rotatable washing drum of a washing machine.

### BACKGROUND OF THE INVENTION

WO 2011/134690 A1 discloses a dosing system comprising a dosing device and a container. The dosing device serves to dose a specific amount of the preparation in the container during a wash cycle. The dosing device and the container are accommodated in a spherical housing. During a wash cycle, the freely movable dosing system and the laundry in the washing drum are moved. The spherical dosing system and the laundry can rub against and bump into each other, which can cause damage to the laundry and the dosing system. If the speed is too low, the spherical dosing system inside the washing drum can collide with the inner wall of the washing drum if the washing drum is not fully filled. The impact leads to a mechanical shock load on the dosing system. This shock load can occur 1000 times or more during a single wash cycle, assuming that with each rotation of the washing drum the spherical dosing system is first carried upwards and then falls downwards at a certain point. The impact of the dosing system inside the washing drum also creates a disruptive noise.

WO 2019/121295 A1 also describes a freely movable dosing system with a spherical housing as well as a dosing device and container arranged therein. In one embodiment, the housing is constructed in two layers, with an outer layer made of a thermoplastic elastomer and the inner layer made of a harder thermosetting or thermoplastic plastics material. The thermoplastic elastomer dampens and cushions shocks acting on the dosing system during the wash cycle. The spherical housing therefore makes a decisive contribution to the reliable and consistent functionality of the dosing system.

The dampening and cushioning effect of the outer layer depends on the material properties of the chosen material and the layer thickness. Although a thicker layer generally leads to better protection, this involves the use of more material. A softer material that is advantageous for dampening and cushioning shocks can, however, have a high coefficient of friction. A high coefficient of friction means higher friction forces between the dosing system and the laundry, which can place greater strain on and damage the dosing system and the laundry.

### BRIEF SUMMARY OF THE INVENTION

The invention is therefore based on the object of providing a dosing system that can be freely positioned in a washing drum of a washing machine, that functions reliably and robustly and whose use does not damage the laundry in the washing machine.

The object of the invention is achieved by the combination of features according to claim 1. Embodiments of the invention can be found in the dependent claims of claim 1.

### DETAILED DESCRIPTION OF THE INVENTION

According to the invention, it is provided that a sphere surface of the housing is covered with a ribbed structure, which has a plurality of spaced-apart ribs. The individual ribs absorb the impact forces that act on the dosing system with the spherical housing when the dosing system moves inside the washing drum of the washing machine and—in particular when the washing drum is only partially filled—impacts on the inner wall of the washing drum. The ribs act like individual shock absorbers that cushion and absorb the impact. The forces acting on the parts of the dosing system accommodated in the interior of the housing are thus largely absorbed, which mechanically protects the dosing device and the container. The ribbed structure thus allows effective protection against mechanical stress with comparatively little material expenditure.

The distance between adjacent ribs must be selected and the ribs must be placed evenly on the sphere surface of the housing so that one rib and a plurality of ribs can cushion an impact in any alignment or orientation of the dosing system. This provides protection in all directions. The ribbed structure covers the entire sphere surface of the dosing system housing, but this does not exclude the possibility of there being individual locations where the ribs are spaced further apart or where the ribs are interrupted to allow certain functionalities of the dosing system.

A further advantage of the ribbed structure is that the effective friction surface of the dosing system is reduced. The laundry in the washing drum only comes into contact with the radially outward-facing front surface of the individual ribs if the distance between adjacent ribs is not too large. The smaller friction surface leads to lower friction forces, so that the sliding and rubbing against each other on the dosing system puts comparatively little strain on the laundry.

It has also been shown that the ribbed structure makes it easier to grip the dosing system by hand. If the rib spacing is selected so that a human finger fits into the gap between two adjacent ribs and thus a certain amount of reaching behind is possible, this noticeably increases the grip of the dosing system. This means that the dosing system can be easily handled even when it is wet, for example after a wash cycle.

A further advantage of the ribbed structure is that an opening in the sphere surface, which is arranged between two adjacent ribs and through which the preparation passes from the container into the washing drum, is less likely to be covered by laundry lying directly above the opening.

A rib cross section of a single rib, a majority of the ribs, or all of the ribs may have a first rib flank, a second rib flank, and a rib tip where the two rib flanks converge. The rib cross section thus tapers radially outwards, starting from a base circle of the sphere surface. In one embodiment, the rib tip is rounded or flattened. Although rounding the rib tip increases the effective friction surface of the dosing system, it also reduces material wear at the rib tip. For example, the rib cross section may be substantially triangular. The first rib flank and/or the second rib flank can be straight or curved.

As the rib cross section tapers radially outwards, the rib has special damping and cushioning properties. When the washing drum is impacted, the tip of the rib hits the drum first. The damping or cushioning effect in the first phase of the impact is initially small, since only a small amount of material is deformed in the region of the rib tip. Since the rib cross section increases from the rib tip towards the base circle, more and more of the ribbed material is deformed or compressed as the deformation path increases in the second phase of the impact, so that the damping and cushioning effect increases with the deformation path.

In one embodiment, a first transition region between the sphere surface of the housing and the first rib flank has a rounded shape. The rounded shape is designed in such a way that no dirt or liquid residues can form.

A second transition region between the sphere surface of the housing and the second rib flank can also have a rounded shape. The second transition region may differ from the first transition region. This leads to an asymmetrical rib cross section. As a result of the asymmetry of the rib cross section, the rib, which is then subjected to compression, deviates to one side when the dosing system is impacted, which leads to good damping and cushioning.

The asymmetry of the rib cross section can also be achieved by other measures. For example, the first rib flank may be inclined and/or shaped differently than the second rib flank. This can result in the rib tip not being in the middle of the rib cross section.

The ribs are preferably formed integrally on the sphere surface. For example, the ribbed structure and the sphere surface of the housing can be seamlessly injection-molded. This gives the sphere surface with the ribbed structure placed thereon mechanical stability with good damping and cushioning properties.

The rib cross section of at least some of the ribs may vary in the longitudinal direction. For example, the rib cross section at the beginning of the rib may be wider or higher than the rib cross section at the end of the rib or in a middle region of the rib.

The outer diameter of the dosing system can be 70 mm to 130 mm. The outer diameter should also include the ribbed structure on the spherical housing. In one embodiment, the outer diameter is 90 to 110 mm.

The height of the rib cross section (distance between the base circle and the rib tip) can be 3 to 10 mm, preferably 5 to 8 mm. The width of the rib cross section at the level of the base circle can be in a range from 1 to 7 mm, preferably from 2 to 6 mm and most preferably from 3 to 5 mm.

The distance between two adjacent ribs (measured from rib tip to rib tip) can be 5 to 25 mm (preferably 8 to 15 mm). The distance between the two adjacent ribs can be constant or vary in the longitudinal direction of the ribs. The height of the rib cross section and the distance are preferably selected so that when the dosing system impacts on the inner wall of the washing drum, the rib or ribs in question absorb the impact energy in such a way that there is no contact between the washing drum and the sphere surface of the housing. The thickness of the layer forming the sphere surface can be selected to be comparatively small, thus saving material.

The ribbed structure may include a plurality of longitudinal ribs extending from a first pole to a second pole that is diametrically opposite the first pole. The longitudinal ribs can wind from the first pole to the second pole in an S-shape. The S-shape has exactly one turning point.

In the vicinity of the first pole, a first annular rib may be arranged in the shape of a circle, the center of which is arranged coaxially to the first pole, wherein the longitudinal ribs start at the annular rib and run in the direction of the second pole. The longitudinal ribs can converge at one point at the second pole. Alternatively, a second annular rib in the shape of a circle can be arranged on the second pole, so that the longitudinal ribs start from the first annular rib and end at the second annular rib. The second annular rib is preferably arranged coaxially to the second pole.

The housing of the dosing system accommodates a container for holding a preparation and a dosing device that doses the preparation from the container into the washing drum. The dosing device can be arranged in the vicinity the first pole and have a control unit which can be actuated by a pressure force directed at the first pole. The dosing device can therefore be switched on and off from outside, for example. The first annular rib encloses the first pole and serves as a protective barrier against unintentional pressure on the control unit. If, for example, the dosing system impacts against the inner wall of the washing drum with the first pole, it is the first annular rib that absorbs the impact energy. The diameter of the first annular rib may be 20 to 40 mm.

In one embodiment, an additional annular rib with a closed circumference is provided, wherein the circumference surrounds a charging region of the dosing device. The closed circumference can, for example, have the shape of a circle or an oval. For example, the dosing device can be charged by induction.

In addition to the design measures already mentioned, the damping and cushioning of the ribbed structure are also influenced by an appropriate choice of material. Preferred materials are those that have at least one hard-elastic and at least one soft-elastic phase. Particularly preferred are materials in which the soft elastic phase lies between two hard elastic phases in the molecular structure or at the structural level. Furthermore, the materials are characterized by a low and a high glass transition temperature; the distance between the two glass transition temperatures is at least 10 K, preferably at least 15 K and particularly preferably 20 K. A preferred material is a thermoplastic elastomer which comprises styrene and butadiene.

The design measures and materials described above make it possible to achieve a significant reduction in noise emissions compared to a dosing system without a ribbed structure. In particular, the ribbed structure prevents or reduces low-frequency noise (<3000 Hz). Tests have shown that, compared to a dosing system without a ribbed structure, the dosing system according to the invention reduces the noise level at frequencies between 130 Hz and 1000 Hz by several dB. The tests were carried out with 2 kg of household laundry and with 4.5 kg of household laundry.

The invention is explained in more detail with reference to the embodiments shown in the drawings, in which:

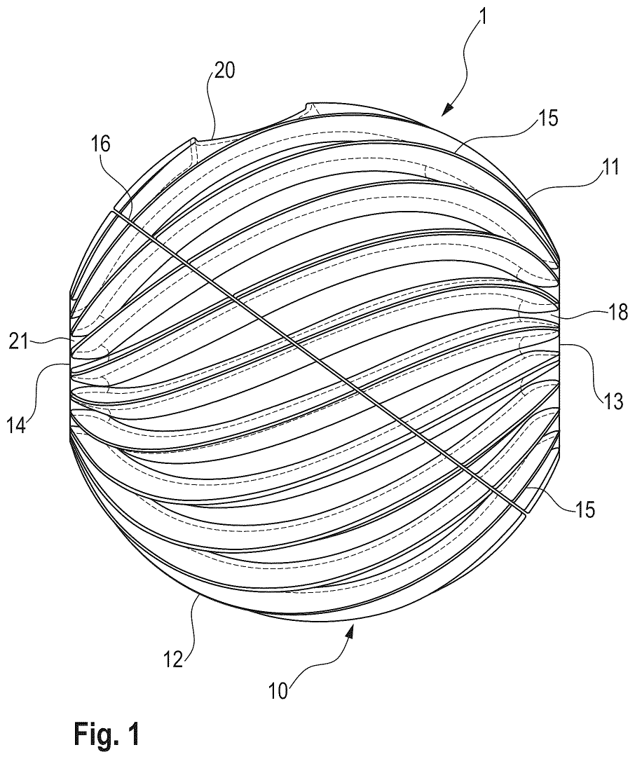

FIG. 1 shows a dosing system according to the invention with a spherical housing;

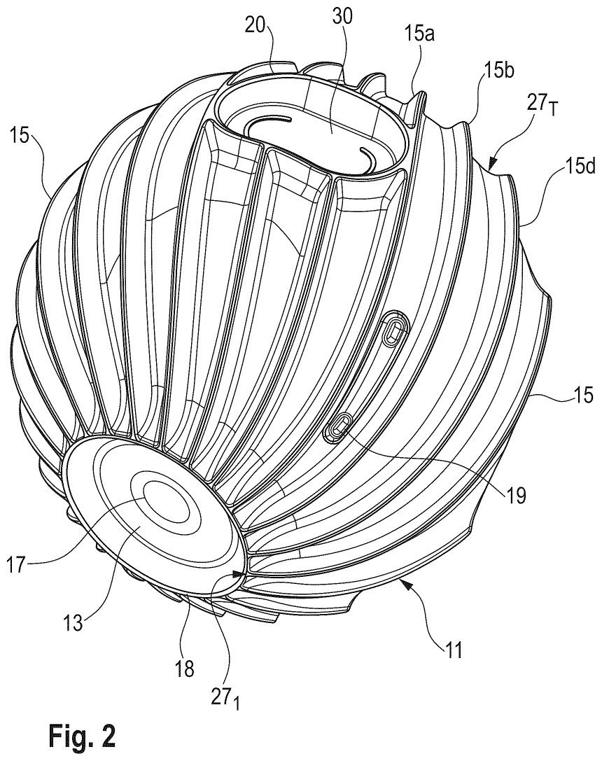

FIG. 2 is a perspective view of a first housing half of the spherical housing;

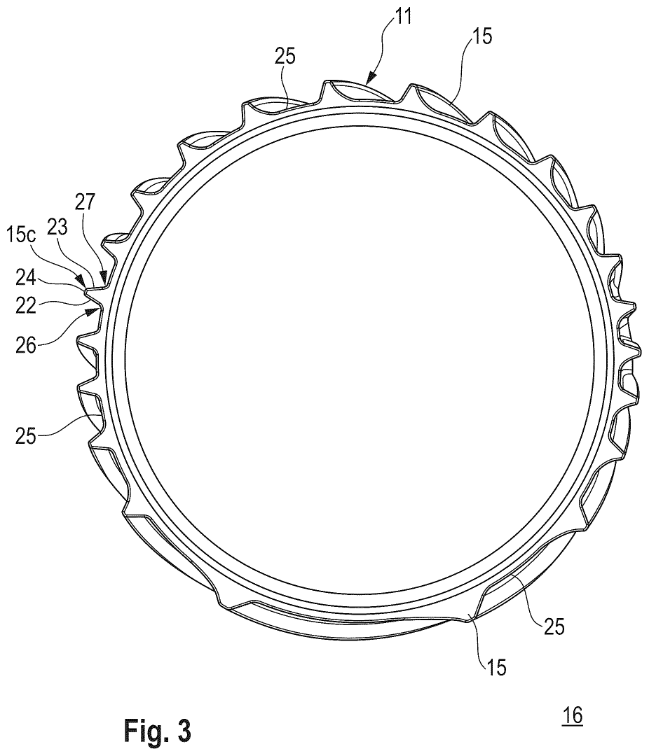

FIG. 3 is a plan view of the first housing half of FIG. 2; and

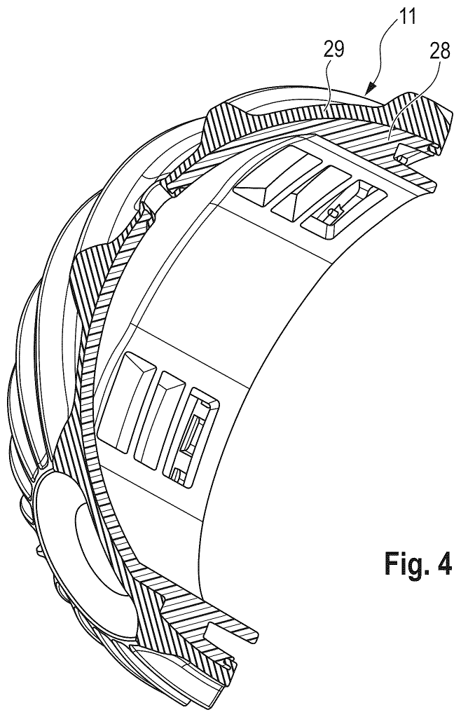

FIG. 4 shows a section through the housing half of FIG. 2.

FIG. 1 shows a dosing system which is denoted in its entirety by 1. The dosing system 1 can be placed in the washing drum of a standard household washing machine and can be moved freely therein. The dosing system 1 has a spherical housing 10 with a first housing half 11 and a second housing half 12, which are separated by a flat separating surface 16. A dosing device and a container for a flowable preparation are accommodated inside the spherical housing 10. The dosing device removes the flowable preparation or a portion of the preparation from the container and doses it into the washing drum during a wash cycle. The preparation may be a detergent or a fragrance.

The spherical housing 10 has a first pole 13 and a second pole 14. The first pole 13 and the second pole 14 are diametrically opposite each other. Both the first pole 13 and the second pole 14 are flattened. The term “spherical” should therefore also include shapes that deviate slightly from the shape of a sphere in the mathematical sense.

The sphere surface of the housing 10 is covered with a plurality of S-shaped ribs 15 which extend from the first pole 13 to the second pole 14. These ribs running from pole to pole can also be referred to as longitudinal ribs 15. The longitudinal ribs 15 have exactly one turning point between the first pole 13 and the second pole 14.

FIG. 1 also shows that the longitudinal ribs 15 on the second pole 14 meet a second circular annular rib 21. As at the first pole 13, the longitudinal ribs 15 do not converge at one point, but end at the circumference of a circular annular rib.

FIG. 2 is a perspective view of the first housing half 11. A control element 17 of the dosing device is arranged on the first pole 13 so that the dosing device can be operated by pressing a finger from outside through the housing. The first pole 13 is surrounded by a first annular rib 18, from which the longitudinal ribs 15 start and run in the direction of the second pole.

Between two longitudinal ribs 15a, 15b, two openings 19 are provided in the sphere surface, which openings allow an exchange of the preparation between the interior of the dosing system 1 and the washing drum. In addition to dispensing the preparation into the washing drum, the exchange may also include ventilating the container. The container can be ventilated via separate openings.

FIG. 2 shows a further annular rib 20 with a closed circumference in the shape of an oval. The annular rib 20 surrounds a charging region 28 through which it is possible to electrically charge the dosing device from the outside by induction. The dosing system 1 can thus operate autonomously and, if necessary, receive signals from the washing machine and, if necessary, send signals to the washing machine. Alternatively, or additionally, signals can be exchanged between the dosing system 1 and another instance. The dosing system 1 can also send and/or receive signals to/from a charging console or to/from any mobile or stationary device.

FIG. 3 is a plan view of the first housing half 11, wherein the separating surface 16, which can be seen in FIG. 1, coincides with the drawing plane in the representation of FIG. 3. The individual longitudinal ribs 15 intersect the separating surface 16 at different angles. The illustrated portion of the longitudinal rib 15c runs perpendicular to the separating surface 16, so that FIG. 3 shows its rib cross section. The rib cross section has a first rib flank 22, a second rib flank 23, and a rounded or flattened rib tip 24. A first transition region 26 is provided between a base circle 25, which is part of the sphere surface of the housing 10, and the first rib flank 22. The first transition region 26 has a rounded shaped so that no dirt or moisture can settle there. A transition region is also provided between the second rib flank 23 and the base circle 25, namely a second transition region 27. It is clear from FIG. 2 that the transitions 26, 27 (the second transition 27 of the longitudinal rib 15d can be seen here) vary along the longitudinal direction of the longitudinal rib 15. Thus, the transition 271 in the region of the first pole 13 is narrower than the transition 27T in the region of the separating plane 16.

FIG. 4 shows a section through the first housing half 11. The first housing half 11 (and also the second housing half 12) have an inner layer 28 and an outer layer 29, wherein the longitudinal ribs 15 and the outer layer 29 are formed in one piece. The outer layer 29 and the longitudinal ribs 15 are made of a thermoplastic elastomer. The inner layer 26 is made of a plastics material that is harder than the thermoplastic elastomer.

If, during a wash cycle in which the washing drum rotates and the dosing system 1 is moved within the washing drum, the dosing system 1 impacts against the inner wall of the washing drum, the soft material of the longitudinal ribs 15 or the annular ribs 18, 20, 21 absorbs the corresponding impact energy, so that the parts located in the interior of the spherical housing 10 are protected against excessive mechanical stress. As a result of the special shape of the rib cross section, a soft impact is achieved, since the rib in question, which is compressed during the impact, is only compressed in the region of the rib tip 24 in the first phase of the impact, where only a small amount of material is deformed.

Furthermore, it is clear from the figures that the effective friction surface of the dosing system 1, i.e., the surface of the dosing system 1 that comes into contact with the laundry, is quite small. It corresponds to the sum of the area of the rib tips 24 of all ribs, whereby it is assumed that the distance between adjacent ribs is so small that the laundry comes into contact with the dosing system 1 only at the rib tips 24. Accordingly, only low frictional forces act on the laundry. The ribs make the dosing system 1 easy to grip with one hand and easy to hold even when it is still wet after a wash cycle. The soft impact of the dosing system caused by the ribs also leads to low noise emissions.

### LIST OF REFERENCE SIGNS

1 Dosing system
10 Housing
11 First housing half
12 Second housing half
13 First pole
14 Second pole
15 Ribs/longitudinal ribs
16 Separating plane
17 Control element
18 First annular rib
19 Opening
20 Additional annular rib
21 Second annular rib
22 First rib flank
23 Second rib flank
24 Rib tip
25 Base circle
26 First transition region
27 Second transition region
28 Inner layer
29 Outer layer
30 Charging region

What is claimed is:

1. A dosing system for dosing a preparation into a washing machine, wherein the dosing system can be freely positioned in a rotatable washing drum of a washing machine, comprising a container for receiving the preparation, a dosing device that doses the preparation from the container into the washing drum, and a substantial spherical housing in which the dosing device and the container are accommodated, wherein a sphere surface of the housing is covered with a ribbed structure, which has a plurality of spaced-apart ribs.

2. The dosing system according to claim 1, wherein a cross section of each of the ribs has a first rib flank, and a second rib flank.

3. The dosing system according to claim 2, wherein a first transition region between the sphere surface of the housing and the first rib flank has a rounded shape.

4. The dosing system according to claim 3, wherein a second transition region between the sphere surface of the housing and the second rib flank has a rounded shape, wherein the second transition region differs from the first transition region.

5. The dosing system according to claim 1, wherein the ribs are formed integrally on the sphere surface.

6. The dosing system according to claim 2, wherein the cross section of each of the ribs varies in the longitudinal direction.

7. The dosing system according to claim 2, wherein the height of the cross section is 5 to 15 mm.

8. The dosing system according to claim 1, wherein the distance between two adjacent ribs is 5 to 25 mm.

9. The dosing system according to claim 1, wherein the ribbed structure has a plurality of longitudinal ribs which extend from a first pole to a second pole diametrically opposite the first pole.

10. The dosing system according to claim 9, wherein the longitudinal ribs each wind in an S-shape from the first pole to the second pole.

11. The dosing system according to claim 9, characterized in that in the vicinity of the first pole, a first annular rib is arranged in the shape of a circle, the center of which is arranged coaxially to the first pole, wherein the longitudinal ribs start at the annular rib and run in the direction of the second pole.

12. The dosing system according to claim 9, wherein the dosing device is arranged in the vicinity of the first pole and has a control unit which can be actuated by a pressure force directed at the first pole.

13. The dosing system according to claim 1, further comprising an additional annular rib with a closed circumference, wherein the circumference surrounds a charging region of the dosing device.

14. The dosing system according to claim 1, wherein the ribs are made of a thermoplastic elastomer which comprises styrene and butadiene.

15. The dosing system according to claim 2, wherein the cross section further comprises a rounded or flattened rib tip.
